(19) United States
(12) Patent Application Publication
(10) Pub. No.: US 2021/0260761 A1
(43) Pub. Date: Aug. 26, 2021

(54) Method And Control System For Controlling An Industrial Actuator

(71) Applicant: ABB Schweiz AG, Baden (CH)

(72) Inventors: Mikael Norrlöf, Norrköping (SE); Markus Enberg, Västerås (SE); Morten Åkerblad, Västerås (SE); Philippe Charles, L'ISLE ADAM (FR); Jan Bronkhorst, Amersfoort (NL); Ron Nakken, Bunsbeek (BE); Haayo Terpstra, Amersfoort (NL)

(21) Appl. No.: 17/254,275

(22) PCT Filed: Jul. 4, 2018
(86) PCT No.: PCT/EP2018/068071

§ 371 Date: Dec. 19, 2020

(51) Int. Cl. B25J 9/16; G05B 19/416

(52) U.S. Cl. CPC B25J 9/1664; G05B 2219/39242; G05B 19/416

(57) ABSTRACT

A method for controlling an industrial actuator (26), the method comprising defining a movement path (10) as a sequence of a plurality of consecutive movement segments (14), where each movement segment (14) is defined between two points (16); defining at least one blending zone (12, 50, 52) associated with one of the points (16) between two consecutive movement segments (14), wherein the blending zone (12, 50, 52) is defined independently in relation to each of the two consecutive movement segments (14); and executing the movement path (10) comprising the blending zone (12, 50, 52) by the industrial actuator (26). A control system (30) for controlling an industrial actuator (26) and an actuator system (24) comprising an industrial actuator (26), are also provided.

### TECHNICAL FIELD

The present disclosure generally relates to control of an industrial actuator. In particular, a method and a control system for controlling an industrial actuator to execute a movement path comprising at least one blending zone are provided.

### BACKGROUND

A robot program typically comprises a plurality of programmed positions or points for determining a movement path of a tool center point (TCP) or a distal end of an arm of an industrial robot. The robot program can determine a fully defined movement path between consecutive points, for example by assuming linear movement segments between the points. The movement segments may be said to constitute the building blocks for the movement path.

It is previously known to define a blending zone associated with one or more points of the movement path. By defining a blending zone around a fly-by point, the point is never attained when executing the movement path since the direction of motion is changed before the point is reached. Today, the blending zones are circular and the radii of the blending zones associated with fly-by points cannot be made larger than half the distance to the closest point (forwards or backwards). If a larger blending zone is specified, the size of the blending zone is automatically reduced to half the distance to the closest point.

FIG. 1 schematically represents one example of a movement path 10 to be followed by an industrial actuator (not shown) and two blending zones 12b, 12c according to the prior art. The movement path 10 is defined as a sequence of a plurality of movement segments 14a, 14b, 14c. In the example in FIG. 1, the first movement segment ma is defined between a first point 16a and a second point 16b, a second movement segment 14b is defined between the second point 16b and a third point 16c, and a third movement segment 14c is defined between the third point 16c and a fourth point 16d. FIG. 1 further shows a circular second programmed blending zone 18b and a circular third programmed blending zone 18c associated with the second point 16b and the third point 16c, respectively. In the example in FIG. 1, the second point 16b and the third point 16c are fly-by points, meaning that the programmed point may never be attained when executing the movement path 10 by an industrial actuator. Instead, the direction of motion is changed before each of the points 16b, 16c is reached.

Furthermore, in the example in FIG. 1, the first point 16a and the fourth point 16d are stop points, meaning that the industrial actuator makes a full stop at these points. Stop points are one type of fine points. A fine point means that the industrial actuator (and optionally an external device) must reach the specified position before program execution continues with the next instruction. Fine points may alternatively be referred to as zero zones. FIG. 1 further shows a defined second blending zone 12b and a defined third blending zone 12c. In the present disclosure, the movement segments 14a, 14b, 14c, the programmed blending zones 18b, 18c, the points 16a, 16b, 16c, 16d, and the defined blending zones 12b, 12c may also be referred to with reference numeral “14”, “18”, “16” and “12”, respectively.

In the example in FIG. 1, the two programmed blending zones 18b, 18c overlap. The second programmed blending zone 18b extends beyond 50% of the length of the first movement segment 14a, and the third programmed blending zone 18c extends beyond 50% of the length of each of the second movement segment 14b and the third movement segment 14c.

In order to avoid this overlap, it is known to reduce the radius of each of the programmed blending zones 18b, 18c to 50% of the shortest of the movement segments 14a, 14b, 14c associated with the programmed blending zones 18b, 18c. As can be seen in FIG. 1, the first movement segment ma associated with the second point 16b is shorter than the second movement segment 14b associated with the second point 16b and the third movement segment 14c associated with the third point 16c is shorter than the second movement segment 14b associated with the third point 16c. Thus, in accordance with prior art, the radius of the second programmed blending zone 18b is reduced such that the second blending zone 12b is defined with a radius corresponding to 50% of the length of the first movement segment ma and the third programmed blending zone 18c is reduced such that the third blending zone 12c is defined with a radius corresponding to 50% of the length of the third movement segment 14c.

The flexibility of the definitions of the blending zones 12b, 12c is limited since the blending zones 12b, 12c are defined symmetrically as circles. As can be seen in FIG. 1, the defined blending zones 12b, 12c are relatively small. There may therefore be relatively long distances between two adjacent blending zones 12 where no blending is taking place. In FIG. 1 for example, there is a relatively long distance between the second blending zone 12b and the third blending zone 12c along the second movement segment 14b. As a consequence, the maximum obtainable smoothness and speed when executing the movement path 10 by an industrial actuator is limited. These problems are further enhanced when the length ratio between two consecutive movement segments 14 is higher, e.g. for a blending zone 12 associated with a point 16 between a very long movement segment 14 and a very short movement segment 14. That is, if one movement segment 14 is much shorter, the blending zone 12 may be defined as much less than 50% of the longer movement segment 14.

US 2009037021 A1 relates to motion control and planning algorithms to facilitate execution of a series of moves within a motion trajectory. In one example, a trajectory is specified as a sequence of one or more path segments. A velocity profile is calculated for each of the one or more path segments, wherein each velocity profile is divided into a blend-in region, a blend-out region and a remainder region. Each path segment is executed such that the blend-in region of its velocity profile overlaps only with the blend-out region of the previous profile.

### SUMMARY

One object of the present disclosure is to provide a method for controlling an industrial actuator, which method provides a smoother motion of the industrial actuator.

A further object of the present disclosure is to provide a method for controlling an industrial actuator, which method provides a faster motion of the industrial actuator.

A still further object of the present disclosure is to provide a method for controlling an industrial actuator, which method reduces wear of the industrial actuator.

A still further object of the present disclosure is to provide a method for controlling an industrial actuator, which method reduces the cycle time for an operation involving the industrial actuator.

A still further object of the present disclosure is to provide a method for controlling an industrial actuator, which method solves several or all of the foregoing objects.

A still further object of the present disclosure is to provide a control system for controlling an industrial actuator, which control system solves one, several or all of the foregoing objects.

A still further object of the present disclosure is to provide an actuator system comprising a control system and an industrial actuator, which actuator system solves one, several or all of the foregoing objects.

According to one aspect, there is provided a method for controlling an industrial actuator, the method comprising defining a movement path as a sequence of a plurality of consecutive movement segments, where each movement segment is defined between two points; defining at least one blending zone associated with one of the points between two consecutive movement segments, wherein the blending zone is defined independently in relation to each of the two consecutive movement segments; and executing the movement path comprising the blending zone by the industrial actuator.

The points may be constituted by programmed positions in a program of the industrial actuator, e.g. a robot program. The blending zone is used to specify how a first of two consecutive movement segments is to be terminated and how a second of the two consecutive movement segments is to be initiated, i.e. how close to the point between the two consecutive movement segments the industrial actuator must be before moving towards the next point.

By defining the blending zone independently, i.e. by determining the blending zone expressed independently in each of the two consecutive movement segments associated with the blending zone, a flexible definition of the blending zone is provided. Instead of being limited by symmetry, the shapes of the blending zones according to the present disclosure are allowed to vary and to be asymmetric. This flexible definition enables larger blending zones to be applied to points of a movement path. For each blending zone that can be made larger, the smoothness of the movement of the industrial actuator can be increased, the speed of the movement of the industrial actuator can be increased, and/or the cycle time for an operation involving the industrial actuator can be reduced, when executing the movement path. With the method, it is also possible to reduce the wear and increase the lifetime of the industrial actuator (and/or of an external device of an actuator system comprising the industrial actuator) by utilizing a shorter movement path, slowing down the industrial actuator and still keep the same cycle time as before the method is applied.

Throughout the present disclosure, each movement segment may be constituted by a linear interpolation between two consecutive points of the movement path. However, the interpolation may alternatively be general, i.e. not necessarily linear. The interpolation can be made with different types of Cartesian base functions, such as lines, circle segments and splines. Also an interpolation in joint coordinates of the industrial actuator and/or an interpolation for tool orientation is possible.

The blending zone may be defined by means of two zone borders, and each zone border may be defined in relation to a respective one of the two consecutive movement segments. Alternatively, or in addition, the blending zone may be defined with a factor from 0 to 1, or with a percentage of between 0% and 100%, in relation to each of the two consecutive movement segments. The factor may be constituted by an interpolation index that has the value 0 in the point associated with the blending zone and the value 1 in each adjacent point.

The blending zone may be defined with a different factor in relation to each of the two consecutive movement segments. In case one or more points of the movement path are fine points, at least one blending zone associated with a fly-by point may be defined as 100% of the movement segment between the fly-by point and the fine point. The same blending zone may still be defined independently in relation to the other movement segment associated with the blending zone. Thus, a previous limitation of the blending zone of 50% of the movement segment towards a fine point can be removed.

The at least one blending zone may comprise a first blending zone associated with a first point. In this case, the method may further comprise defining at least one second blending zone associated with a second point, consecutive with the first point; and determining if there is an overlap between the first blending zone and the second blending zone.

The method may further comprise modifying the definitions of the first blending zone and the second blending zone, in relation to the movement segment between the first point and the second point, to an average value in relation to the movement segment between the first point and the second point, if it is determined that there is an overlap between the first blending zone and the second blending zone.

As an alternative, the method may further comprise reducing the largest of the first blending zone and the second blending zone, by modifying the definition in relation to the movement segment between the first point and the second point until the overlap is eliminated, if it is determined that there is an overlap between the first blending zone and the second blending zone.

As a further alternative, the method may further comprise reducing the blending zone of the first blending zone and the second blending zone that has the lowest priority, by modifying the definition in relation to the movement segment between the first point and the second point until the overlap is eliminated, if it is determined that there is an overlap between the first blending zone and the second blending zone. That is, a high priority blending zone will limit any adjacent blending zone of lower priority.

An adjacent lower priority blending zone may however still be larger than 50% (in relation to the movement segment between the points associated with the high priority blending zone and the low priority blending zone) if the higher priority blending zone is smaller than 50% (in relation to the movement segment between the points associated with the high priority blending zone and the low priority blending zone). High priority may be applied to any blending zone of the movement path, e.g. associated with a start point or end point, or with any intermediate point.

According to one example, the movement path comprises a high priority blending zone, associated with an intermediate point, between two low priority blending zones, associated with a respective adjacent point. In this case, each of the two adjacent points may be constituted by a fly-by point having a relatively large blending zone (e.g. at least 90%) and the intermediate point may be constituted by a fly-by point having a relatively small blending zone (e.g. maximum 10%). The use of a movement path comprising an intermediate fine point, or an intermediate fly-by point having a relatively small blending zone with high priority, between two adjacent blending zones having relatively large blending zones of lower priority, is advantageous in case the intermediate point is a handling point (e.g. pick or place point) on a conveyor belt.

The defining of at least one blending zone associated with one of the points may comprise defining at least two blending zones, and each blending zone may be defined independently in relation to each of the two consecutive movement segments.

The method may further comprise simultaneously executing two consecutive movement segments within one of the at least one blending zone. Such blending zone may be referred to as a Cartesian position blending zone throughout the present disclosure.

The method may further comprise initiating a reorientation of a tool of the industrial actuator towards an orientation of the tool associated with one of the points, when the industrial actuator reaches one of the at least one blending zone associated with that point. Such blending zone may be referred to as an orientation blending zone throughout the present disclosure. If the blending zone is too small, there is less of a risk of having to reduce the velocity of the industrial actuator to carry out the reorientation of the tool. Reorientation will be smoother if the size of the blending zone is increased.

The method may further comprise initiating an operation of an external device associated with one of the points of the movement path, when the industrial actuator reaches one of the at least one blending zone associated with that point. Throughout the present disclosure, the blending zone for triggering such initiation of an operation of the external device may be referred to as an external device blending zone or an external axis blending zone. For example, a movement of the external device towards a position associated with the point may be initiated when the industrial actuator reaches the external device blending zone. In this way, a slow external device can start accelerating at an earlier stage and a process involving both the industrial actuator and the external device can be executed more smoothly.

The external device may for example be constituted by an additional industrial robot (in case the industrial actuator is constituted by an industrial robot), a rotatable table or any type of handling device. One example of such handling device may be a painting device associated with a point where paint spraying is initiated when the industrial actuator reaches the external device blending zone associated with that point.

The method according to the present disclosure may comprise defining only a Cartesian position blending zone, only an orientation blending zone, or only an external device blending zone, independently in relation to each of the two consecutive movement segments. Alternatively, the defining of at least one blending zone may comprise defining any combination of a Cartesian position blending zone, an orientation blending zone, and an external device blending zone, independently in relation to each of the two consecutive movement segments.

Throughout the present disclosure, the industrial actuator may be an industrial robot.

According to a further aspect, there is provided a control system for controlling an industrial actuator, the control system comprising a data processing device and a memory having a computer program stored thereon, the computer program comprising program code which, when executed by the data processing device, causes the data processing device to perform the steps of defining a movement path as a sequence of a plurality of consecutive movement segments, where each movement segment is defined between two points; defining at least one blending zone associated with one of the points between two consecutive movement segments, wherein the blending zone is defined independently in relation to each of the two consecutive movement segments; and commanding the industrial actuator to execute the movement path comprising the blending zone. The control system may further be configured to control the industrial actuator, and optionally an external device, according to each method in the present disclosure.

According to a further aspect, there is provided an actuator system comprising a control system according to the present disclosure and an industrial actuator, such as an industrial robot. The actuator system may further comprise an external device, such as a further industrial robot or a positioning table.

### BRIEF DESCRIPTION OF THE DRAWINGS

Further details, advantages and aspects of the present disclosure will become apparent from the following embodiments taken in conjunction with the drawings, wherein:

FIG. 1: schematically represents a movement path and blending zones according to the prior art;

FIG. 2: schematically represents a movement path and blending zones according to one embodiment of the present invention;

FIG. 3: schematically represents blending of movement segments within the blending zones of the movement path in FIG. 2;

FIG. 4: schematically represents a side view of an actuator system comprising an industrial actuator, an external device and a control system according to one embodiment of the present invention;

FIG. 5: schematically represents a movement path and three blending zones associated with a point according to one embodiment of the present invention; and

FIGS. 6a-6f: schematically represents various phases of execution of the movement path in FIG. 5.

### DETAILED DESCRIPTION

In the following, a method and a control system for controlling an industrial actuator to execute a movement path comprising at least one blending zone, will be described. The same reference numerals will be used to denote the same or similar structural features.

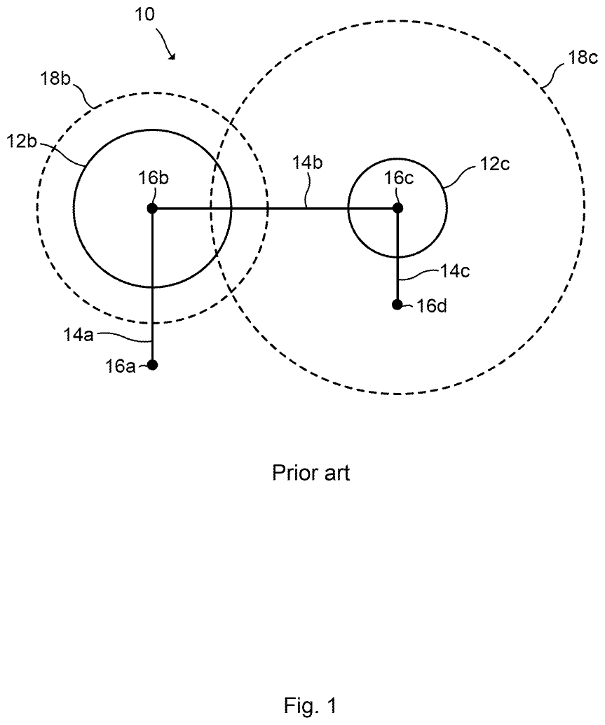

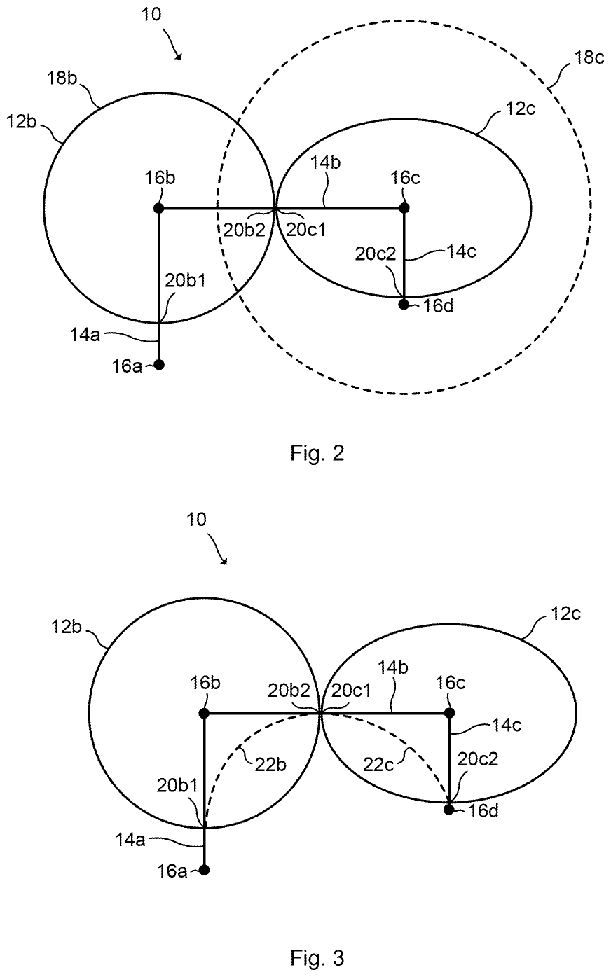

FIG. 2 schematically represents a movement path 10 and blending zones 12b, 12c according to one embodiment of the present invention. The movement path 10 in FIG. 2 comprises the same points 16, the same consecutive movement segments 14 between the points 16, and the same programmed blending zones 18b, 18c, as the movement path 10 in FIG. 1. However, the blending zones 12 are defined differently in FIG. 2.

The movement path 10 in FIG. 2 is two-dimensional but may alternatively be three-dimensional. In FIG. 2, two consecutive movement segments 14 are executed simultaneously in each blending zone 12 associated with the point 16 between the two consecutive movement segments 14. The movement path 10 may for example be followed by the TCP of the industrial actuator. For this reason, the blending zones 12b, 12c in FIG. 2 may be referred to as TCP blending zones or as Cartesian position blending zones.

The first point 16a and the fourth point 16d are fine points (stop points). Therefore, no blending zones are defined in association with these points.

The second blending zone 12b is defined independently in relation to each of the two consecutive movement segments 14a, 14b and the third blending zone 12c is defined independently in relation to each of the two consecutive movement segments 14b, 14c. As a consequence, the blending zones 12b, 12c are not limited by symmetry.

The blending zones 12 may be defined in various ways. According to one example, the blending zones 12 are defined by means of zone borders. In FIG. 2, the definition of the second blending zone 12b in relation to the first movement segment 14a and the second movement segment 14b may be made by means of two second zone borders 20b1, 20b2, respectively, and the definition of the third blending zone 12c in relation to the second movement segment 14b and the third movement segment 14c may be made by means of two third zone borders 20c1, 20c2, respectively (the zone borders 20b1, 20b2, 20c1, 20c2 may also be referred to with reference numeral “20”).

The maximum allowable size for a blending zone 12 may be exceeded for several reasons, including for example lack of skill or care by the programmer, changes made to the movement path 10, e.g. a reduced length of a movement segment 14, and automatic generation of the movement path lo based on sensor input, from e.g. a vision system, where the lengths of the movement segments 14 are not known beforehand. The method according to the present invention may comprise a limitation on the maximum size of each blending zone 12. One example of such limitation is that each blending zone 12 should be defined with a factor between 0 and 1 (i.e. between 0% and 100%) in relation to each of the two consecutive movement segments 14 with which the blending zone 12 is associated. In the example in FIG. 2, the definition of the second programmed blending zone 18b in relation to the first movement segment ma is approximately 75% and the definition of the second programmed blending zone 18b in relation to the second movement segment 14b is approximately 50%. Thus, the second programmed blending zone 18b does not need to be reduced due to exceeding a maximum size. The second blending zone 12b may therefore be defined as the second programmed blending zone 18b.

Furthermore, the definition of the third programmed blending zone 18c in relation to the second movement segment 14b is approximately 75%, which is well within this limitation. However, the definition of the third programmed blending zone 18c in relation to the third movement segment 14c is approximately 200%. Therefore, the definition of the third blending zone 12c is reduced to 100% in relation to the third movement segment 14c. The third blending zone 12c is thereby allowed to extend all the way to the fine point 16d.

In FIG. 2, there is an overlap between the second programmed blending zone 18b and the third programmed blending zone 18c. Various reasons for such overlap exist, including for example lack of skill or care by the programmer and changes made to the movement path 10, e.g. a reduced length of the second movement segment 14b. The method according to the present invention may comprise determining if there is an overlap between two consecutive blending zones 12. Instead of setting each defined blending zone 12b, 12c to a circle having a radius corresponding to 50% of the length of the shortest of the two consecutive movement segments 14 with which the blending zone 12 is associated according to the prior art, the present invention provides for alternative ways of handling such overlaps.

One measure of handling overlaps includes modifying the definitions of the second blending zone 12b and the third blending zone 12c to an average value in relation to the second movement segment 14b, if it is determined that there is an overlap between the second blending zone 12b and the third blending zone 12c. In FIG. 2, the definition of the second programmed blending zone 18b in relation to the second movement segment 14b is already 50% of the length of the second movement segment 14b. Thus, the second programmed blending zone 18b remains unchanged and also constitutes the defined second blending zone 12b. However, since the definition of the third programmed blending zone 18c in relation to the second movement segment 14b is beyond 50% (approximately 75%) in FIG. 2, the definition of the third blending zone 12c in relation to the second movement segment 14b (but not in relation to the third movement segment 14c) is reduced to the average value of 50%.

An alternative measure of handling overlap includes reducing the largest of the second programmed blending zone 18b and the third programmed blending zone 18c. In FIG. 2, the third programmed blending zone 18c is larger than the second programmed blending zone 18b. Therefore, the definition of the second programmed blending zone 18b in relation to the second movement segment 14b is unchanged and the definition of the third programmed blending zone 18c in relation to the second movement segment 14b is reduced until the overlap is eliminated.

As an alternative measure of handling overlap, one or more programmed blending zones 18 may be prioritized. If for example the second programmed blending zone 18b is prioritized, the second programmed blending zone 18b remains unchanged (given that the second programmed blending zone 18b is defined with a factor from 0 to 1 in relation to each of the two consecutive movement segments 14a, 14b) and thereby constitutes the defined second blending zone 12b. In this case, the third programmed blending zone 18c, which has a lower priority than the second programmed blending zone 18b, is reduced by reducing the definition in relation to the second movement segment 14b until the overlap is eliminated.

In each of the above three examples, the blending zones 12b, 12c will be defined as illustrated in FIG. 2. As can be seen in FIG. 2, the definition of the second blending zone 12b in relation to the first movement segment ma is larger than 50% and the third blending zone 12c is defined as an ellipse.

Except for an optional limitation in maximum size of the blending zones 12, the blending zones 12 are only limited by the size of one or two adjacent blending zones 12 and eventually by distances to closest points. By defining the zone borders 20 of each blending zone 12 independently, the blending zones 12 can be made much larger.

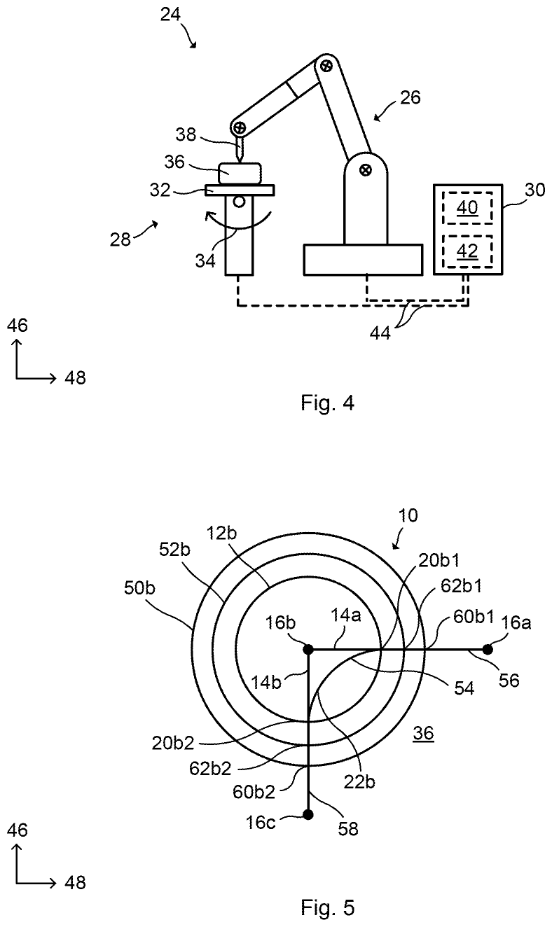

FIG. 3 schematically represents blending of movement segments 14 within the blending zones 12 of the movement path 10 in FIG. 2. In the example of FIG. 3, the two consecutive movement segments 14a, 14b are executed simultaneously in the second blending zone 12b and the two consecutive movement segments 14b, 14c are executed simultaneously in the third blending zone 12c, when executing the movement path 10 by the industrial actuator. Due to this simultaneous execution of consecutive movement segments 14, the industrial actuator follows a defined curve 22b in the second blending zone 12b and a defined curve 22c in the third blending zone 12c (the curves 22b, 22c may also be referred to with reference numeral “22”). In the example in FIG. 3, the curves 22b, 22b are linearly blended between the respective pairs of associated movement segments 14.

The curves 22b, 22c define the movement path 10 within the respective blending zones 12b, 12c. This defined movement path 10 is the same regardless of speeds and accelerations of the industrial actuator along the movement path 10. The geometry of the movement path 10 is defined independently of the dynamics of the industrial actuator. A dynamic coupling, e.g. speeds and accelerations of the industrial actuator along the movement path 10, may be generated in a second step to define a movement trajectory. The movement path 10 within the blending zones 12 may however be blended in various ways. Instead of curves 22, the movement path 10 may for example adopt various polynomial shapes within the blending zones 12. The movement path 10 within each blending zone 12 may alternatively be referred to as a corner path.

As illustrated in FIG. 3, when executing the movement path 10 by the lo industrial actuator, the movement path 10 starts in the first point 16a and ends in the fourth point 16d, or vice versa. Since the first point 16a and the fourth point 16d are stop points, the industrial actuator makes a full stop at these points. However, due to the blending zone 12b and the blending zone 12c, the industrial actuator is allowed to fly-by the second point 16a and the third point 16c. The movement path 10 is thereby made more smooth and acceleration and deceleration phases along the movement path 10 can be reduced or eliminated. As a consequence, the speed of the industrial actuator can be increased and the wear on mechanical components of the industrial actuator can be reduced.

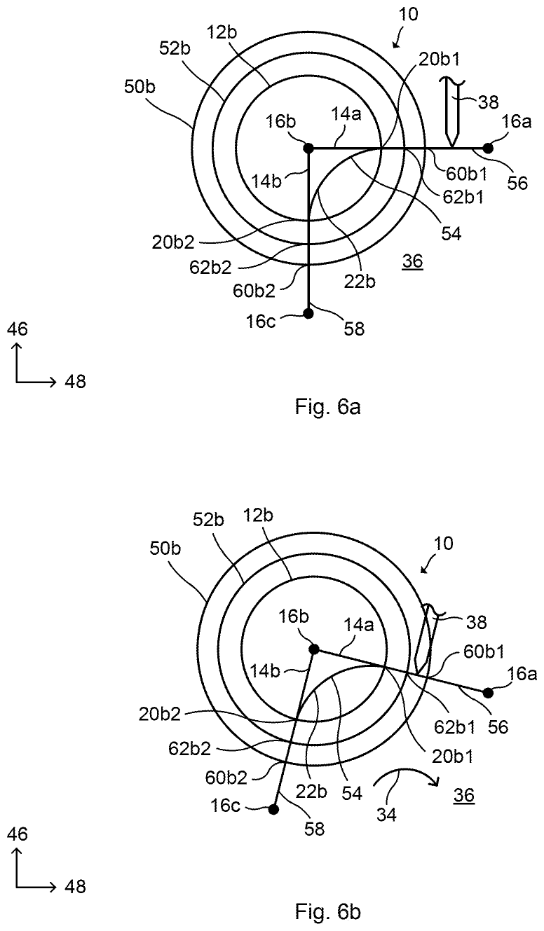

FIG. 4 schematically represents a side view of an actuator system 24 comprising an industrial actuator 26, an external device 28 and a control system 30 according to one embodiment of the present invention. In the example of FIG. 4, the industrial actuator 26 is exemplified as an industrial robot. The external device 28 is exemplified as an external actuator comprising a reorientable table 32. The external device 28 may however, for example, alternatively be constituted by an additional industrial robot.

The external device 28 is configured to rotate the table 32 around an axis perpendicular to the plane of FIG. 4, as illustrated with arrow 34. The table 32 may however be moved in two or more axes, such as up to six axes. An object 36 is secured to the table 32. The industrial actuator 26 comprises a tool 38, for example a welding tool, for performing a handling operation on the object 36.

The control system 30 is configured to control the industrial actuator 26 and optionally the external device 28 according to the present invention. The control system 30 comprises a data processing device 40 (e.g. a central processing unit, CPU) and a memory 42. A computer program is stored in the memory 42. The computer program comprises program code which, when executed by the data processing device 40, causes the data processing device 40 to perform the steps of defining a movement path 10 as a sequence of a plurality of consecutive movement segments 14, where each movement segment 14 is defined between two points 16; defining at least one blending zone 12 associated with one of the points 16 between two consecutive movement segments 14 of the movement path 10, wherein the blending zone 12 is defined independently in relation to each of the two consecutive movement segments 14 associated with the point 16; and commanding the industrial actuator 26 to execute the movement path 10 comprising the Cartesian position blending zone 12, an external device blending zone and/or an orientation blending zone. In the example of FIG. 4, the control system 30 is in communication with the industrial actuator 26 and the external device 28 by means of signal lines 44.

FIG. 4 further denotes a vertical axis 46 and a first horizontal axis 48 of a Cartesian coordinate system for referencing purposes. The industrial actuator 26 and the external device 28 may however be oriented arbitrarily in space.

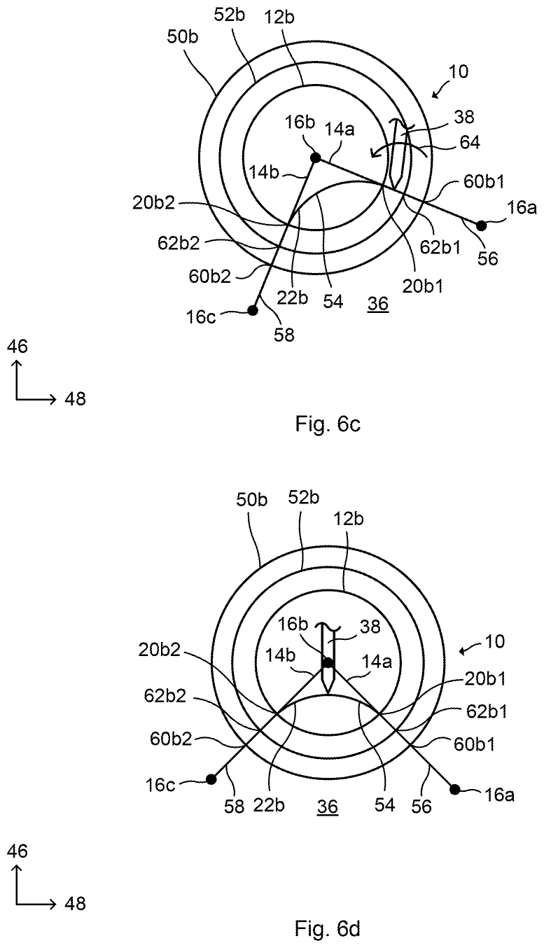

FIG. 5 schematically represents a movement path 10 and three blending zones 12b, 50b, 52b associated with a point 1613 according to one embodiment of the present invention. In addition to a Cartesian position blending zone 12b as described in connection with FIGS. 2 and 3, the movement path 10 of the example in FIG. 5 comprises two additional blending zones 50b, 52b. The additional blending zone 50b is constituted by an external device blending zone (which may also be referred to with reference numeral “50”) and the additional blending zone 52b is constituted by an orientation blending zone (which may also be referred to with reference numeral “52”). Each of the three blending zones 12b, 50b, 52b may be defined independently in relation to each of the two consecutive movement segments 14a, 14b associated with the point 16b, as described in connection with the blending zone 12 in FIGS. 2 and 3. Thus, each of the three blending zones 12b, 50b, 52b may be handled in parallel. FIG. 5 further shows that the object 36 of this example comprises a curved profile 54 between its top surface 56 and its perpendicular side surface 58. The programming of the movement path 10 may be made in a coordinate system (not shown) of the table 32.

During execution of the movement path 10 by the industrial actuator 26, an operation of the external device 28 associated with the point 16b is initiated when the industrial actuator 26 reaches the external device blending zone 50b associated with the point 16b, e.g. when the industrial actuator 26 reaches the one of two zone borders 60b1, 60b2 of the external device blending zone 50b (the zone borders 60b1, 60b2 may also be referred to with reference numeral “60”). Furthermore, during execution of the movement path 10 by the industrial actuator 26, a reorientation of the tool 38 towards an orientation of the tool 38 associated with the point 16b is initiated when the industrial actuator 26 reaches the orientation blending zone 52b associated with the point 16b, e.g. when the industrial actuator 26 reaches one of two zone borders 62b1, 62b2 of the orientation blending zone 52b (the zone borders 62b1, 62b2 may also be referred to with reference numeral “62”).

In the example of FIG. 5 the external device blending zone 50b is an outermost blending zone, the orientation blending zone 52b is a middle blending zone and the Cartesian position blending zone 12b is an inner blending zone. However, the order of the blending zones 12b, 50b, 52b may be set differently and two or more of the blending zones 12b, 50b, 52b may partly or fully overlap. In particular, the Cartesian position blending zone 12b may be defined as an inner blending zone and the external device blending zone 50b and the orientation blending zone 52b may be defined as a common outer blending zone.

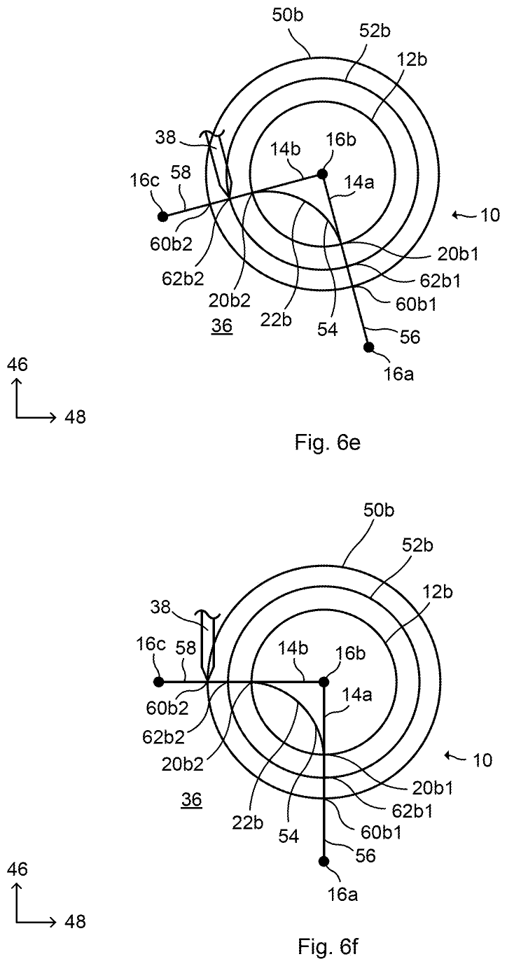

FIGS. 6a-6f schematically represents various phases of execution of the movement path 10 in FIG. 5. The execution of the movement path 10 is made in connection with a handling operation of the tool 38 on the object 36. The handling operation may be constituted by a welding operation where it may desired to maintain the surface at the welding point substantially horizontal and/or the tool 38 substantially perpendicular to the surfaces of the object 36. However, in order to clearly demonstrate the properties of the blending zones 12, 50, 52, the surface at the welding point of the object 36 is not maintained perfectly horizontal at all times and the tool 38 is not maintained perfectly perpendicular to the surfaces of the object 36 at all times in FIGS. 6a-6f.

In FIG. 6a, the tool 38 moves along the movement segment 14a. The top surface 56 of the object 36 is oriented horizontally. The first movement segment ma partly follows the top surface 56 of the object 36 (until the zone border 20b1 of the Cartesian position blending zone 12b). The tool 38 is oriented perpendicular to the top surface 56 of the object 36.

As shown in FIG. 6b, when the tool 38 has passed the zone border 60b1 of the external device blending zone 50b, the external device 28 initiates a rotation of the table 32 towards a 90° rotation associated with the point 16b. The tool 38 still follows the top surface 56 of the object 36 and the tool 38 is maintained in an orientation perpendicular to the top surface 56.

As shown in FIG. 6c, when the tool 38 has passed the zone border 62b1 of the orientation blending zone 52b, the industrial actuator 26 initiates a reorientation of the tool 38, as indicated by arrow 64, towards a 90° orientation of the tool 38 associated with the point 1613 (in the coordinate system of the table 32). As can be seen in FIG. 6c, the orientation of the tool 38 starts to deviate slightly from the previous perpendicular orientation with respect to the top surface 56 of the object 36.

As shown in FIG. 6d, the tool 38 follows the curve 22b of the Cartesian position blending zone 12b, which conforms to the curved profile 54 of the object 36 between the top surface 56 and the side surface 58. Furthermore, in FIG. 6d, the rotation of the table 32 towards the 90° rotation associated with the point 16b has come halfway (i.e. 45°) and the reorientation of the tool 38 towards the 90° orientation of the tool 38 associated with the point 16b has come halfway (i.e. 45°).

As shown in FIG. 6e, at the same time as the tool 38 reaches the zone border 62b2 of the orientation blending zone 52b, the orientation of the tool 38 reaches the 90° orientation of the tool 38 associated with the point 16b.

As shown in FIG. 6f, at the same time as the tool 38 reaches the zone border 60b2 of the external device blending zone 50b, the rotation of the table 32 reaches the 90° orientation of the table 32 associated with the point 16b.

The flexible definitions of the blending zones 12, 50, 52 according to the example in FIGS. 6a-6f may thereby contribute to a reduced cycle time (e.g. if the reorientation of the tool 38 and/or the operation of the external device 28 is comparatively slow) for operations involving the industrial actuator 26.

The definitions of the blending zones 12, 50, 52 may also contribute to an improved performance of a handling operation, e.g. by maintaining a surface horizontal and/or by maintaining the tool 38 perpendicular.

While the present disclosure has been described with reference to exemplary embodiments, it will be appreciated that the present invention is not limited to what has been described above. For example, it will be appreciated that the dimensions of the parts may be varied as needed.

1. A method for controlling an industrial actuator, the method comprising:
defining a movement path as a sequence of a plurality of consecutive movement segments, where each movement segment is defined between two points;
defining at least one blending zone associated with one of the points between two consecutive movement segments, wherein the blending zone is defined independently in relation to each of the two consecutive movement segments; and
executing the movement path comprising the blending zone by the industrial actuator.

2. The method according to claim 1, wherein the blending zone is defined by means of two zone borders, and wherein each zone border is defined in relation to a respective one of the two consecutive movement segments.

3. The method according to claim 1, wherein the blending zone is defined with a factor from 0 to 1 in relation to each of the two consecutive movement segments.

4. The method according to claim 3, wherein the blending zone is defined with a different factor in relation to each of the two consecutive movement segments.

5. The method according to claim 1, wherein the at least one blending zone comprises a first blending zone associated with a first point, and wherein the method further comprises:
defining at least one second blending zone associated with a second point, consecutive with the first point; and
determining if there is an overlap between the first blending zone and the second blending zone.

6. The method according to claim 5, further comprising modifying the definitions of the first blending zone and the second blending zone, in relation to the movement segment between the first point and the second point, to an average value in relation to the movement segment between the first point and the second point, if it is determined that there is an overlap between the first blending zone and the second blending zone.

7. The method according to claim 5, further comprising reducing the largest of the first blending zone and the second blending zone, by modifying the definition in relation to the movement segment between the first point and the second point until the overlap is eliminated, if it is determined that there is an overlap between the first blending zone, and the second blending zone.

8. The method according to claim 5, further comprising reducing the blending zone of the first blending zone and the second blending zone that has the lowest priority, by modifying the definition in relation to the movement segment between the first point and the second point until the overlap is eliminated, if it is determined that there is an overlap between the first blending zone and the second blending zone.

9. The method according to claim 1, wherein the defining of at least one blending zone associated with one of the points comprises defining at least two blending zones and wherein each blending zone is defined independently in relation to each of the two consecutive movement segments.

10. The method according to claim 1, wherein the method further comprises simultaneously executing two consecutive movement segments within one of the at least one blending zone.

11. The method according to claim 1, wherein the method further comprises initiating a reorientation of a tool of the industrial actuator towards an orientation of the tool associated with one of the points, when the industrial actuator reaches one of the at least one blending zone associated with that point.

12. The method according to claim 1, wherein the method further comprises initiating an operation of an external device associated with one of the points of the movement path, when the industrial actuator reaches one of the at least one blending zone associated with that point.

13. The method according to claim 1, wherein the industrial actuator is an industrial robot.

14. A control system for controlling an industrial actuator, the control system comprising a data processing device and a memory having a computer program stored thereon, the computer program comprising program code which, when executed by the data processing device, causes the data processing device to perform the steps of:
defining a movement path as a sequence of a plurality of consecutive movement segments, where each movement segment is defined between two points;
defining at least one blending zone associated with one of the points between two consecutive movement segments wherein the blending zone is defined independently in relation to each of the two consecutive movement segments; and
commanding the industrial actuator to execute the movement path comprising the blending zone.

15. An actuator system comprising a control system and an industrial actuator, the control system including a data processing device and a memory having a computer program stored thereon, the computer program having program code which when executed by the data processing device, causes the data processing device to perform the steps of:
defining a movement path as a sequence of a plurality of consecutive movement segments, where each movement segment is defined between two points;
defining at least, one blending zone associated with one of the points between two consecutive movement segments, wherein the blending zone is defined independently in relation to each of the two consecutive movement segments; and
commanding the industrial actuator to execute the movement path comprising the blending zone.

16. The method according to claim 2, wherein the blending zone is defined with a factor from 0 to 1 in relation to each of the two consecutive movement segments.

17. The method according to claim 2, wherein the at least one blending zone comprises a first blending zone associated with a first point, and wherein the method further comprises:
defining at least one second blending zone associated with a second point, consecutive with the first point; and
determining if there is an overlap between the first blending zone and the second blending zone.

18. The method according to claim 2, wherein the defining of at least one blending zone associated with one of the points comprises defining at least two blending zones, and wherein each blending zone is defined independently in relation to each of the two consecutive movement segments.
